(19) United States
(12) Patent Application Publication
(10) Pub. No.: US 2003/0041011 A1
(43) Pub. Date: Feb. 27, 2003

(54) System and method for conducting a buy-side auction

(76) Inventors: William Grey, Millwood, NY (US); Stuart I. Feldman, Stamford, CT (US); Manoj Kumar, Yorktown Heights, NY (US); Dailun H. Shi, Croton on Hudson, NY (US); Frederick Yung-Fung Wu, Cos Cob, CT (US); Brian T. Eck, Poughquag, NY (US); Brenda L. Dietrich, Yorktown Heights, NY (US)

Correspondence Address: BUCKLEY, MASCHOFF, TALWALKAR, & ALLISON, 5 ELM STREET, NEW CANAAN, CT, 06840, US

(21) Appl. No.: 09/935,153

(22) Filed: Aug. 22, 2001

(51) Int. Cl. G06F 17/60

(52) U.S. Cl. 705/37

(57) ABSTRACT

A system, method, apparatus, and computer program code for conducting a buy-side auction includes defining a plurality of transformation functions available for use in the auction. An offer to sell the item requested in the auction is received from a seller, and at least one transformation function is identified, based at least in part on the offer or the seller. The selected transformation function is applied to the offer to produce a transformed offer, and a state of the auction is updated based on the transformed offer.

### CROSS-REFERENCE TO RELATED APPLICATIONS

This application is related to the following co-pending and commonly assigned U.S. patent applications (the content of each of which is hereby incorporated by reference herein for all purposes):

U.S. patent application Ser. No. ______, filed ______ (on even date herewith) for “SYSTEM AND METHOD FOR PERSONALIZED DYNAMIC PRICING” (Attorney Docket No. I01.50 and Client Docket No. YOR920010388US1);

U.S. patent application Ser. No. ______, filed ______ (on even date herewith) for “SYSTEM AND METHOD FOR CONDUCTING A SELL-SIDE AUCTION” (Attorney Docket No. I01.51 and Client Docket No. YOR920010409US1);

U.S. patent application Ser. No. ______, filed ______ (on even date herewith) for “SYSTEM AND METHOD FOR CONDUCTING A TWO-SIDED AUCTION” (Attorney Docket No. I01.53 and Client Docket No. YOR920010411US1);

U.S. patent application Ser. No. ______, filed ______ (on even date herewith) for “SYSTEM AND METHOD FOR ESTABLISHING CUSTOMIZED LEASING TERMS” (Attorney Docket No. I01.54 and Client No. YOR920010412US1);

U.S. patent application Ser. No. ______, filed ______ (on even date herewith) for “SYSTEM AND METHOD FOR FACILITATING TRANSACTIONS AMONG DISPARATE ENTITIES” (Attorney Docket No. I01.55 and Client Docket No. YOR920010413US); and

U.S. patent application Ser. No. ______, filed ______ (on even date herewith) for “SYSTEM AND METHOD FOR BUNDLING GOODS” (Attorney Docket No. I01.56 and Client Docket No. YO920010414US1).

### FIELD OF THE INVENTION

The present invention generally relates to commerce systems and methods. More particularly, embodiments of the present invention relate to systems and methods for conducting sales of goods and services.

### BACKGROUND OF THE INVENTION

Auctions have proliferated with the advent of the Internet and advances in communication. Many businesses use auctions and marketplaces to buy and sell goods and services and often enjoy great savings and efficiencies as a result. The essential premise of an auction is that prices are determined as a result of competition between bidders for items offered for sale or purchase. These benefits, however, are only realized when more than one bidder is competing for the same item.

A number of different auctions styles and types have developed over the years to encourage different types of competitions among bidders, including, for example: English auctions, Dutch auctions, Japanese auctions, sealed-bid auctions, double auctions, multiple-unit auction, time interval auctions, call auctions, first price auctions, uniform second price auctions, bundle auctions, and multi-attribute auctions.

Many of these types of auctions may be conducted as either one or two-sided auctions. One-sided auctions allow only bids or asks (but not both). One-sided auctions may be run as open or sealed-bid auctions, and as forward or reverse auctions. Two-sided (or double) auctions allow both bids and asks to take place at the same time. The term auction as defined herein shall also include exchanges, which are electronic or online marketplaces that facilitate a many-to-many trading relationship among or between buyers and sellers. Exchanges are commonly referred to by a number of names, including a trading hub, a vortex, an online marketplace, butterfly market, a bid-ask, an e-marketplace, an e-market, an ehub, a net market maker, an eMarket, a vertical marketplace, or a horizontal marketplace. The term auction as defined herein shall also include bulletin boards and other online commerce platforms that facilitate or enable one-to-many or many-to-many trading relationships among or between buyers and sellers. These various types of auctions and marketplaces are generally known in the art.

One type of two-sided auction is the “continuous double auction’ where many individual transactions are carried on simultaneously and where trading does not stop when a match occurs. Examples of such auctions are financial or securities exchanges such as intra-day trading on the New York Stock Exchange. Another type of two-sided auction is a call auction, where bids and offers are aggregated, then periodically cleared. Examples of such auctions are the opens at the New York Stock Exchange and periodic calls on the Paris Bourse.

Some auctions and marketplaces are completely automated. In other cases, non-automated entities facilitate, support or otherwise enable marketplace transactions, potentially providing a number of benefits, including increasing market liquidity, and ensuring orderly price movements. For example, “specialists” serve this role on the New York Stock Exchange, and market-makers serve this role on the NASDAQ. As defined herein, auctions include both purely automated marketplaces, and marketplaces in which non-automated entities facilitate, support or otherwise enable marketplace transactions.

A common feature of most of these auctions and marketplaces is that they are generally used to sell or acquire relatively homogeneous goods or services. Without standardization of the goods or services, it is difficult to generate sufficient competition among bidders to achieve the benefits that auctions provide. As a result, auctions are typically not suited for many types of non-standardized goods or services.

Further, auctions are typically not suited for many types of business-to-business environments. Many business-to-business transactions rely on existing relationships between the buyer and the seller. For example, sellers often provide strategic partner discounts to buyers with whom they have a longstanding relationship. Strategic customers expect, and often receive, volume discounts, preferred credit terms, and higher service levels than other customers. Channel partners expect to pay lower prices than their customers. Most existing auctions do not encourage or permit this type of differentiation between participants. Most existing auctions treat all participants as equals. Buyers who purchase in volume pay the same price as buyers who purchase in smaller lots. In fact, buyers who purchase in volume may sometimes pay more than buyers who purchase in smaller lots, since purchases by large buyers may have an impact on the market price of the good or service being transacted, since the size of these purchases results in an imbalance between supply and demand in the market, and may be viewed as a signal regarding future price movements.

Typically, existing auctions treat the bids of strategic, or long-standing customers or suppliers the same as bids from brand new customers or suppliers. It would be desirable to provide an auction and exchange system and method that allows participants to be treated differently, while still allowing these different participants to take part in the same auction.

Existing auctions are also not well-suited to the sale of differentiated or mass-customized products. Such products are often bundled with value-added services or contain a variety of special features and configurations. Items offered for sale or purchase using existing auctions are not typically customizable. Bidders all bid on the same configuration. As a result, because of their specialized nature, items sold at existing auctions may not attract enough interested bidders to generate active bidding. Many buyers and sellers in existing auctions attempt to minimize this problem by compromising and offering standard product configurations. These standard configurations lack differentiation and often sell at lower, commodity prices. Low commodity pricing can lead to price erosion in other channels and for other products, as customers and channel partners in other sales channels begin demanding comparable pricing.

A number of auction mechanisms have attempted to address some of these shortcomings. Multi-attribute auctions and exchanges allow bidders to negotiate over the attributes of an item, as well as its price, thus seeking to address the issue of auctioning differentiated goods and services. However, determining the winner of a multi-attribute auction often requires complex analysis, and is not readily transparent to market participants. This makes it difficult for auction participants to understand the bidding process, and may raise concerns about whether the auction is matching bids and offers in an equitable fashion. In addition, multi-attribute auctions often require bidders to specify the relative value they place on different attributes. In many cases, bidders may not know clearly the relative value they place on different attributes, or may have difficulty specifying it. This also creates difficulties for another reason. In many cases it may not be in the bidders' interest to be completely forthcoming about this information, and thus they may withhold or misrepresent this information. Unfortunately, these misrepresentations can distort the auction results.

Combinatorial auctions and combinatorial exchanges allow bidders to negotiate for bundles of items. Typically, bidders specify the relative importance they place on different bundles of items, and the auction performs an optimization to match bids and offers in a fashion that maximizes the benefit to market participants. Unfortunately, combinatorial auctions and exchanges may suffer from similar drawbacks as multi-attribute auctions. They are complex, making it difficult for auction participants to understand and interpret the bidding process and auction results. In addition, they may require bidders to reveal information that they consider private, and may thus be subject to misrepresentations by auction participants.

It would be desirable to provide a system and method that facilitates customization and product differentiation in auction environments, without introducing the complexities, information distortions, and uncertainties of multi-attribute and combinatorial auctions and exchanges. Preferably, the system and method would permit different participants to competitively bid on customizable products and services in a manner that is flexible, yet straightforward. Further, it would be desirable to provide a system and method that allows participants to competitively bid on equitable terms, despite different treatment for different participants.

### SUMMARY OF THE INVENTION

Embodiments of the present invention provide a system, method, apparatus, and computer program code for conducting a buy-side auction.

According to one embodiment, a buy-side auction process includes defining a plurality of transformation functions available for use in the auction. An offer to sell the desired item(s) requested in the auction is received from a seller, and at least one transformation function is identified, based at least in part on the offer or the seller. The selected transformation function is applied to the offer to produce a transformed offer, and a state of the auction is updated based on the transformed offer.

The result is a system and method which allows sellers in a buy-side auction to compete for items in the auction even if one or more of the sellers is competing from different perspectives. For example, in one embodiment the transformation function applied to an offer is a transformation of an offer amount or an offer quantity. In other embodiments, the transformation function applied to an offer is a transformation of a configuration or bundle of products or services offered in the exchange.

According to one embodiment of the present invention, a registration system and method is provided in which a participant registers to participate. During the registration process, at least a first transformation function is established for the participant. The transformation function may be established based on different information about the participant, the exchange, or others in the exchange. Transformation functions may also be established and associated with sellers, buyers, or offers at various stages of the auction process.

According to one embodiment of the present invention, other information used in the buy-side auction may also be transformed. For example, in one embodiment, status data about a status of the auction is transformed using one or more transformation functions.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a block diagram of a system pursuant to embodiments of the present invention;

FIG. 2 is a diagram depicting a bid and status process of the system of FIG. 1 according to one embodiment of the invention;

FIG. 3 is a block diagram of one embodiment of the auction administrator device of FIG. 1;

FIG. 4 is a tabular representation of a portion of a participant database according to an embodiment of the present invention;

FIG. 5 is a tabular representation of a portion of an auction database according to an embodiment of the present invention;

FIG. 6 is a tabular representation of a portion of a transformation function database according to an embodiment of the present invention;

FIG. 7 is a tabular representation of a portion of a bid database according to an embodiment of the present invention;

FIG. 8 is a flow diagram depicting a transformation binding process according to one embodiment of the present invention;

FIG. 9 is a flow diagram depicting a bid process according to one embodiment of the present invention;

FIG. 10 is a flow diagram depicting a transaction process according to one embodiment of the invention; and

FIG. 11 is a flow diagram depicting a buy-side auction process according to one embodiment of the present invention.

### DETAILED DESCRIPTION

Applicants have recognized that there is a need for a system, method, apparatus, and computer program code for establishing personalized dynamic pricing for auctions or exchanges that involve competitive bidding for items. In particular, Applicants have recognized that the use of one or more transformation functions to transform bids and auction status to personalize the auction experience for multiple differently-situated participants will facilitate competitive bidding between these participants, resulting in overall reduced prices for buyers, and increased demand for sellers. Further, Applicants have recognized that so-called “buy-side” auctions may be operated using features of embodiments of the present invention.

A number of terms are used herein to describe features of embodiments of the present invention. As used herein, the term “auction” will be used to refer to any of a number of formats (known and to be developed) for selling goods or services in a competitive bidding environment. As used herein, the term “auction” may be used to refer to the set of activities that take place to solicit, receive, analyze, and respond to bids for a particular item or items. A number of different auctions may take place at any given time. Each auction involves the interaction of several entities, including at least one buyer, at least one seller, and an auction administrator. In some embodiments, one or more service providers may be involved in an auction, acting on behalf of one or more buyers, sellers, and/or administrators.

As will be described, embodiments of the present invention may be used with a number of different types of auctions, including, for example, those auctions referred to as: English auctions, Dutch auctions, Japanese auctions, sealed-bid auctions, double auctions, multiple-unit auctions, time interval auctions, call auctions, first price auctions, uniform second price auctions, bundle auctions, combinatorial auctions, and multi-attribute auctions. Embodiments of the present invention may also be used with other types of exchanges and marketplaces known in the art.

As used herein, the term “bid” (or the term “submission”) will be used to refer to an offer to purchase or an offer to sell (depending on the type of auction in which the bid is made) received from an auction participant. For the purposes of this disclosure, the term “bidder” will be used to refer to the party submitting a bid. A buyer or a seller (both of which are defined further below) may be a bidder, depending on the type of auction. A bid may include one or more terms of the bid, such as a price term, a quantity term, a configuration term, a delivery term, or the like. The bid may involve an actual purchase or transfer, a contingent purchase or transfer, the purchase or transfer of certain rights, and other types of commercial and non-commercial transactions known in the art.

As used herein, the term “buyer” may be used to refer to a party submitting a bid (an offer to purchase) on an item in an auction. For example, the buyer may be a prospective buyer, submitting an offer to purchase or acquire an item offered in an auction. For the purposes of this disclosure, the term “buyer” refers to prospective buyers as well as the actual purchasers of item(s) by auction. A buyer could also be a human agent representing a prospective buyer, or an intelligent software agent such as a shopping “bot” representing a prospective buyer.

As used herein, the term “seller” may be used to refer to the party offering to sell or provide an item in an auction. For example, the seller may be a prospective seller, submitting a bid (an offer to sell or distribute) on an item offered in an auction. For the purposes of this disclosure, the term “seller” refers to prospective sellers as well as the actual seller of item(s) by auction. A seller could also be a human agent representing a prospective seller, or an intelligent software agent such as a shopping “bot” representing a prospective seller. Both “buyers” and “sellers” will be referred to as “participants” in the auction.

As used herein, the phrase “winning bid” will be used to refer to the bid (either an offer to purchase, an offer to sell, or either an offer to sell or an offer to purchase, depending on the type of auction) which, at the close of the auction, results in the winning participant acquiring the right (or obligation) to purchase or sell the item offered in the auction. Depending on the type of auction, the “winning bid” may not necessarily be the highest priced bid (e.g., in a Dutch auction, the winning bid may be at a lower price than earlier bids). Depending on the type of the auction, there may be multiple “winning bids”. As used herein, the phrase “current best bid” will be used to refer to any bid which, during the conduct of the auction, would be the “winning bid” if the auction were to close without consideration of further bids.

As used herein, the term “administrator” will be used to refer to an entity operating as the coordinator, organizer or facilitator of an auction or exchange. The administrator may be an independent entity operating a commercial auction or exchange, or the administrator may be operating on behalf of a seller or buyer to conduct a closed or private auction with a limited number of participants. The administrator may also be operating on behalf of a seller or buyer to conduct a public auction with a broad range of participants. In embodiments described herein, the administrator will be described as the entity controlling the resources used to solicit information (e.g., bids, auction status data, and transformation data). In some embodiments, the administrator may be an independent entity. In other embodiments, the administrator may be an affiliate of one or more participants in the auction, and/or an affiliate of one or more service providers. In other embodiments, the administrator may be a participant in the auction, or a service provider, or an entity partially or entirely owned or controlled by one or more participants in the auction, or by one or more service providers.

As used herein, the term “service provider” will be used to refer to an entity that provides value-added services such as logistics support, fulfillment, financing, or transaction settlement services that facilitate conducting transactions in an auction or exchange. The service provider may be an independent entity providing services, an entity operating on behalf of an auction administrator, or an entity operating on behalf of a participant (e.g., a buyer or seller) in an auction. In some embodiments, the service provider may be an entity controlling resources used to solicit information (e.g., information used to develop transformation functions or other information used in conjunction with embodiments of the present invention).

As used herein, the term “item” may be used to refer to any of a number of different types of goods or services that may be purchased or sold in an auction or exchange format. As an illustrative example, items that may be purchased or sold using techniques of the present invention may include: differentiated goods, commodities, factor inputs, components, systems, subsystems, devices, raw materials, manufactured products, services, options to purchase goods or services, financial instruments, claims on assets, contingent claims on assets, or the like. An “item” may be an individual component, device or service. An “item” may also be a grouping of individual components, devices or services (sometimes referred to herein and in the art as a “lot” or as a “bundle”). An “item” may also be an assemblage of components and/or services into a system (sometimes referred to herein and in the art as a “configuration”).

System

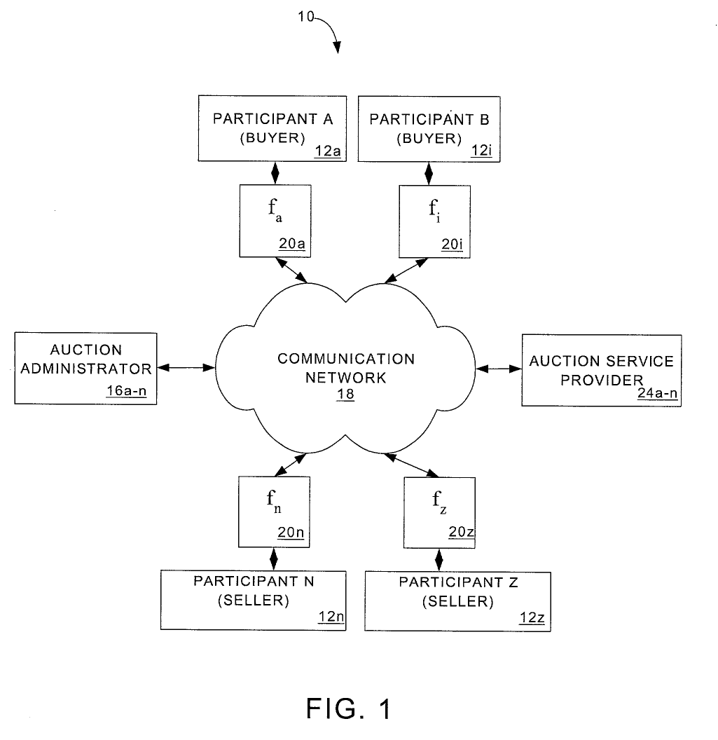

Referring first to FIG. 1, an auction system 10 according to embodiments of the present invention is shown. As shown in FIG. 1, auction system 10 includes a number of participants operating participant devices 12. The participants may include one or more individuals or entities acting as buyers in an auction (and operating buyer devices 12a-i) and who submit offers to purchase items posted for sale or purchase in the auction. The participants also include one or more individuals or entities acting as sellers in an auction (and operating seller devices 12n-z) and who submit offers to sell items in an auction. One or more auction administrators operating auction administrator devices 16a-n may be employed to administer auctions employing features of the present invention. One or more auction service providers operating auction service provider devices 24a-n may be employed to provide value-added services supporting an auction conducted in auction system 10.

Each of these parties may communicate and participate in auctions pursuant to the invention via a communication network 18. Each of the parties, in one embodiment, operates computing devices in communication with communication network 18. These devices will be described further below. For the purpose of describing features of the invention, the party (e.g., the auction administrator) and the device operated by that party (e.g., an auction administrator computing device) may be referred to as either the party or the device (e.g., “participant 12” may also be referred to as “participant device 12”).

In one embodiment of the present invention, an auction utilizing features of the present invention involves one auction administrator operating auction administrator device 16 which is configured as a Web-based server device accessible to participants 12a-z (including participants acting as buyers as well as participants acting as sellers) via the Internet. As will be described further below, the auction operated by the auction administrator via auction administrator device 16 may be any of a number of different types. Participation by buyers and sellers will vary based on the type of auction. For example, in a sell-side auction, a plurality of buyers operating buyer devices 12a-i will interact with an auction administrator operating auction administrator device 16 to submit offers to purchase items posted by one or more sellers operating seller devices 12n-z. In a buy-side auction, a plurality of seller devices 12n-z will interact with auction administrator device 16 to present offers to sell items requested by one or more buyers via buyer devices 12a-i. Other auction or exchange types will involve other forms of interaction known in the art.

Pursuant to one embodiment of the present invention, one or more participants may be associated with one or more transformation functions 20. As will be described further below, these transformation functions 20 are used to modify, adapt, translate or otherwise transform information used in an auction. As an example, a participant such as Participant A (Buyer 12a in FIG. 1) may have an associated transformation function 20a which transforms some or all of the bids submitted by Participant A. For example, transformation function 20a may be a discount that is automatically applied to all bids submitted by Participant A in a certain auction. Other participants may have different transformation functions associated with them. For example, Participant B (Buyer 12b in FIG. 1), acting as a buyer in the same auction as Participant A may be associated with a transformation function 20b that automatically applies a current currency exchange rate to transform Participant B's preferred bid currency to the currency of the auction.

Transformation functions 20 may also be used to modify, adapt, translate or otherwise transform information that is transmitted from auction administrator device 16 to one or more participant devices 12. For example, Participant D may view the status of an auction after the status has been transformed by a transformation function associated with Participant D. Other types and uses of transformation functions 20 pursuant to the present invention will be discussed further below.

Each of the parties operating devices 12, 16 or 24 may communicate via communication network 18, which may be any of a number of different types of commonly-used networks, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Moreover, as used herein, communications include those enabled by wired or wireless technology.

Although some embodiments of the present invention are described with respect to information exchanged using a Web site, according to other embodiments information can instead be exchanged, for example, via: a telephone, an Interactive Voice Response Unit (IVRU), electronic mail, a WEBTV® interface, a cable network interface, and/or a wireless communication system.

Participant devices 12a-z, auction administrator devices 16a-n and auction service provider devices 24a-n may be any devices capable of performing the various functions described herein. In one embodiment, auction administrator devices 16a-n and auction service provider devices 24a-n are configured as Web-based server devices, and participant devices 12a-z are configured as general purpose computing devices. In general, participant devices 12, auction administrator devices 16 and auction service provider devices 24 may be computing devices such as: a Personal Computer (PC), a portable computing device such as a Personal Digital Assistant (PDA), a wired or wireless telephone, a one-way or two-way pager, a kiosk, an interactive television device, or any other appropriate storage and/or communication device.

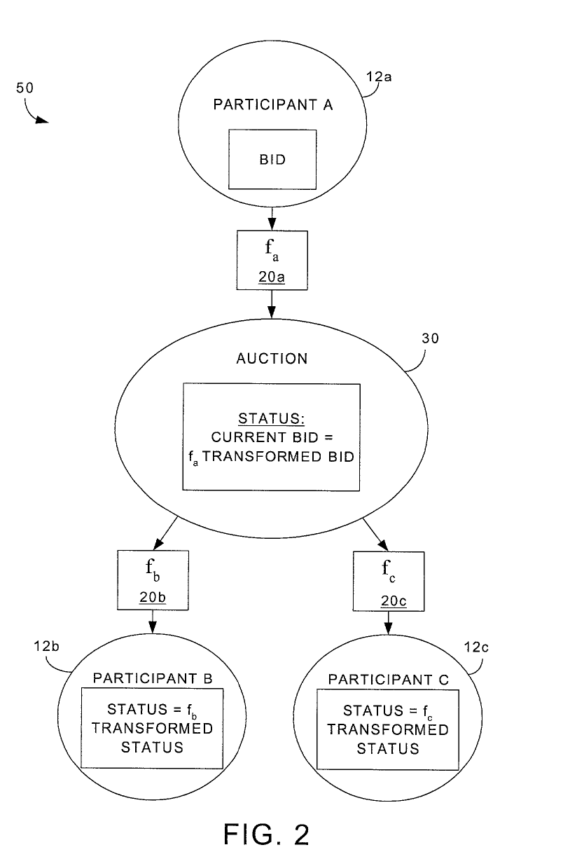

Referring now to FIG. 2, a bid and status process 50 pursuant to embodiments of the present invention is shown. Process 50 will be described to illustrate certain features of embodiments of the present invention. Further details of embodiments of the present invention will be provided below. Process 50 involves interaction between a number of different participants in an auction, referred to here as Participant A, Participant B, and Participant C. In the depicted process, Participant A is participating as a seller in an auction and submits a bid (in this example, the bid is an offer to sell) on an item. This bid may be, for example, submitted to an auction administrator (not shown) running the auction. The bid is transformed by a transformation function 20a. In one embodiment, transformation function 20a is applied by software residing at the participant device 12a operated by Participant A. In another embodiment, it may be applied by software residing at auction administrator device 16. In another embodiment, transformation function 20a may be applied by software residing at an auction service provider device (e.g., item 24 of FIG. 1). In yet other embodiments, the function may be applied by software residing at an seller device (e.g., item 12n-z of FIG. 1). Other techniques for enforcing and applying transformation functions may also be used.

As an example of a transformation function which may be utilized in an auction pursuant to the present invention, Participant A is a preferred seller offering items in the auction, and has been granted a preferred credit for its interactions with the buyer(e.g., a 10% bidding credit on items offered for sale by the seller). According to embodiments of the present invention, transformation function 20a is used to apply this preferred credit to Participant A's bid, resulting in the submission to the auction of a 10% decreased bid. Thus, if participant A could make a $10,000 bid, which, after the preferred transformation function is applied, will result in submission of a transformed bid of $9,000 in the auction. If the auction is a typical forward English auction, subsequent sellers will need to submit an offer lower than Participant A's transformed bid of $9,000 if they wish to remain in the bidding for selling to the buyer

According to embodiments of the present invention, transformation function 20 may be any of a number of different types and combinations of functions. For example, transformation function 20a may be a function that modifies a price of an offer to sell made by Participant A. Transformation function 20a may also be a function that modifies a quantity or description of the item offered to be purchased or sold. Other types and combinations of transformation functions which may be utilized in embodiments of the present invention will be described further below.

As depicted in FIG. 2, application of transformation function 20a results in submission of a transformed bid to the auction. That is, the current status of the auction reflects the submission of a transformed bid (transformed by transformation function 20a). In the example where Participant A receives a 10% preferred bidding credit, Participant A can make a $10,000 bid which has the effect of an $9,000 bid. The current status of the auction, as viewed by certain other participants in the auction, will show that the current best bid is an offer to sell for $9,000, provided that no transformation function is applied to the status information provided to these participants. In a standard English auction, such other sellers in the auction will need to submit an offer to sell lower than $9,000 to stay in the auction.

In most auctions, one or more participants need to be made aware of the status of the auction. For example, other sellers need to know the status of the auction in order to decide whether to continue to participate and submit further bids. According to one embodiment of the present invention, other participants (here, Participants B and C) may view the status of the auction based on further transformations. For example, in the illustrative example where Participant A received a 10% credit on his $10,000 bid, the current bid status shows an offer to sell of $9,000. Participant B may be entitled to a preferred credit of 5%. This discount may be applied as transformation function 20b, resulting in a transformed status being displayed to Participant B (e.g., in the example, Participant B will see that the offer to sell amount to beat is 5% more than $9,000, or $9,450). Participant C, on the other hand, may be bidding using British Pounds, rather than American Dollars. Transformation function 20c may be applied to transform the $9,000 status into an amount reflecting the current status in British Pounds. This transformation may be based on data extrinsic to the auction (e.g., the transformation may require consultation of a source of foreign exchange rate information).

The result is a system that allows multiple participants having different standing to participate in the same auction or exchange. Each participant's special status or standing is automatically applied to their bids and to their viewing of the status of the auction. Further details and benefits of embodiments of the present invention will be described below. A description of one embodiment of an auction administrator device will first be described, along with a discussion of data stored at or accessible to the device pursuant to embodiments of the present invention.

Devices

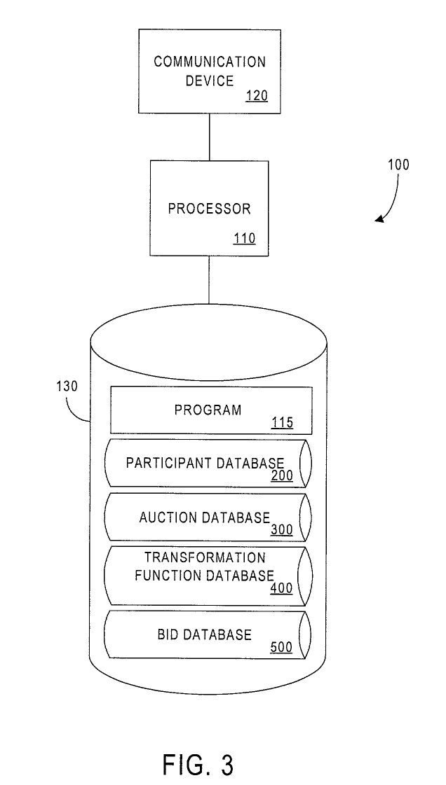

FIG. 3 illustrates an embodiment of an auction administrator device 100 which may be operated by an auction administrator in the system of FIG. 1. Auction administrator device 100 may be used in embodiments where an auction administrator is used to administer and conduct an auction pursuant to the invention. In other embodiments, a buyer, a seller, an auction service provider or other entity may participate in the administration of the auction.

Administrator device 100 may be implemented as a system controller, a dedicated hardware circuit, an appropriately programmed general purpose computer, or any other equivalent electronic, mechanical or electro-mechanical device. Administrator device 100 comprises a processor 110, which may be any of a number of suitable processing devices, such as one or more Intel® Pentium® processors. Processor 110 is coupled to a communication device 120 through which processor 110 communicates with other devices, such as, for example, one or more participant devices 12 operated by buyers and/or sellers participating in the auction, and auction service provider devices 24 operated by auction service providers providing value-added services in support of an auction (each of which devices may also be implemented as general purpose computer or other equivalent electronic, mechanical, or electromechanical device).

Communication device 120 may include hardware and software to facilitate communication with other devices using wired or wireless techniques, or a combination of different techniques. For example, communication device 120 may be one or more of: a network adapter, a modem, a Bluetooth device, etc. In one embodiment, communication device 120 facilitates communication with other devices over a network such as the Internet. Processor 110 may also be in communication with one or more input and output devices (not shown) as are known in the art (such as, for example, a keyboard, mouse, microphone, monitor, printer, etc.).

Processor 110 is also in communication with a data storage device 130. Data storage device 130 comprises an appropriate combination of magnetic, optical and/or semiconductor memory, and may include, for example, Random Access Memory (RAM), Read-Only Memory (ROM), a compact disc and/or a hard disk. Processor 110 and data storage device 130 may each be, for example: (i) located entirely within a single computer or other computing device; or (ii) connected to each other by a remote communication medium, such as a serial port cable, telephone line or radio frequency transceiver. In one embodiment, administrator device 100 may comprise one or more computers that are connected to a remote server computer for maintaining databases.

Data storage device 130 stores a program 115 for controlling processor 110. Processor 110 performs instructions of program 115, and thereby operates in accordance with the present invention, and particularly in accordance with the methods described in detail herein. Program 115 may be stored in a compressed, uncompiled and/or encrypted format. Program 115 furthermore includes program elements that may be necessary for allowing processor 110 to interface with computer peripheral devices, such as an operating system, a database management system and “device drivers”. Appropriate program elements are known to those skilled in the art, and need not be described in detail herein.

According to an embodiment of the present invention, the instructions of program 115 may be read into a main memory from another computer-readable medium, such as from a ROM to RAM. Execution of sequences of the instructions in program 115 causes processor 110 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

Data storage device 130 also stores (i) a participant database 200, (ii) an auction database 300, (iii) a transformation function database 400, and (iv) a bid database 500. These databases are described in detail below and depicted with exemplary entries in the accompanying figures.

Databases

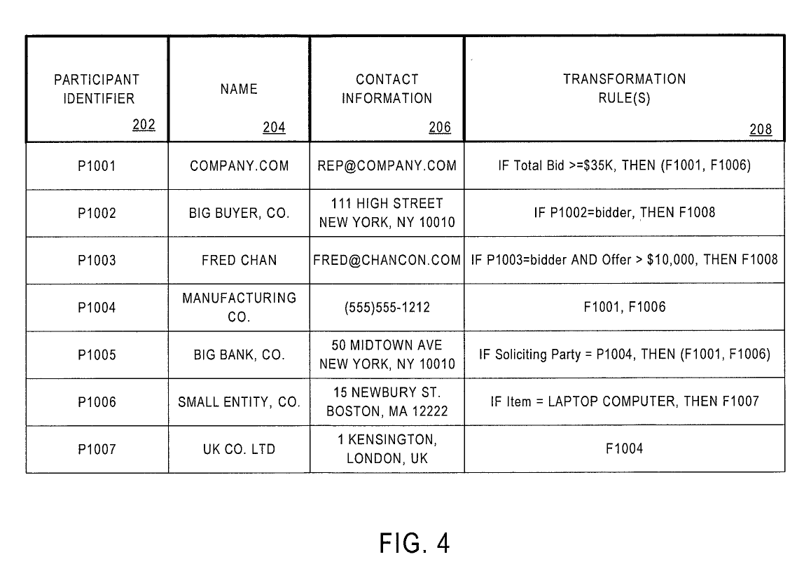

Each of the databases referred to in FIG. 3 will now be described by referring to FIGS. 4-7. While the databases are shown as being stored at, or accessible by, administrator device 100, portions of or all of the data in one or more of the databases may be stored at or accessible to other devices in the system. For example, in some embodiments, transformation functions may be stored at (or accessible to) devices operated by other participants in an auction, such as devices operated by buyers, sellers, or service providers.

As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only; those skilled in the art will understand that the number and content of the entries can be different from those illustrated herein.

Participant Database

Referring to FIG. 4, a table is shown representing a participant database 200 that may be stored at, or accessible by, auction administrator device 100 according to an embodiment of the present invention. The table includes entries identifying a number of different entities and/or individuals that have been identified as participating in an auction pursuant to the present invention. Participants identified in participant database 200 may include parties acting as buyers in an auction as well as parties acting as sellers in an auction. This information may be stored in database 200 when a participant registers for participation in one or more auctions.

The table shown in FIG. 4 defines a number of fields 202-208 for each of the entries. In the embodiment depicted, the fields specify: a participant identifier 202, a name 204, contact information 206, and transformation rule(s) 208. Other fields and combinations of fields may also be used to provide and access information about different participants in an auction and their associated transformation functions.

Participant identifier 202 may be, for example, an alphanumeric code or other information that is associated with and used to identify a participant who has registered to participate in one or more auctions pursuant to embodiments of the present invention. Participant identifier 202 may be generated by, for example, auction administrator device 100 (FIG. 3) or it may be provided by a participant. The participant's individual or company name may be provided in name 204, while information used to contact the participant may be provided in contact information 206.

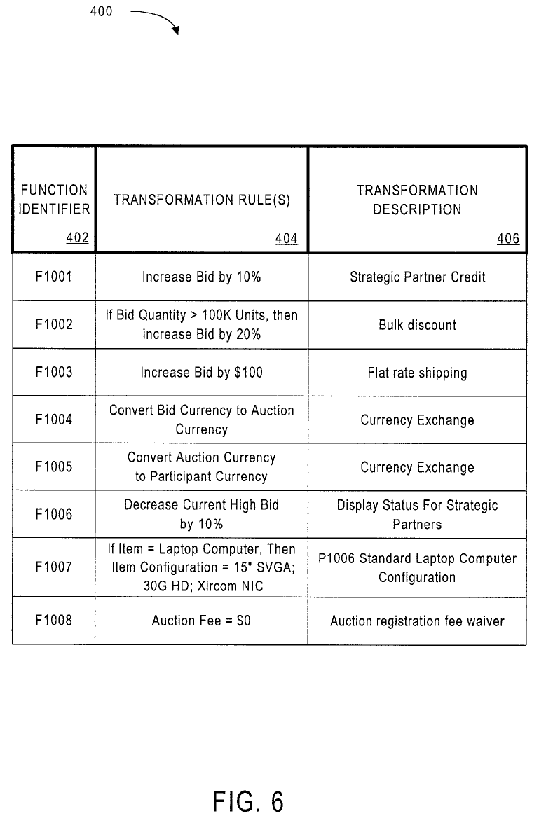

Transformation rule(s) 208 may be, for example, information identifying circumstances in which one or more transformation functions associated with the participant may be applied. Individual transformation functions may be identified by reference to one or more function identifiers (defined in transformation function database 400 described below in conjunction with FIG. 6). Any of a number of different transformation functions may be referenced. Further, any of a number of different rules for applying the transformation functions for a particular participant may also be provided.

For example, in some embodiments, the application of a particular transformation function will depend on the identity of the seller (e.g., the party offering to sell items via auction). In some embodiments, the seller may offer discounts, rebates, or other preferential status to all buyers bidding on its offerings. This preferential status may be identified and applied via rules contained in transformation rule(s) 208.

As another example, in some embodiments, the application of a particular transformation function will depend on the identity of the both the seller (e.g., the party offering to sell items via auction) and the buyer (e.g., the party offering to buy items via auction). For example, in some embodiments, the seller may offer discounts, rebates, or other preferential status to certain buyers. This preferential status may be identified and applied via rules contained in transformation rule(s) 208.

As another example, in some embodiments, the application of a particular transformation function will depend on the identity of the both the seller (e.g., the party offering to sell items via auction) and the nature or identity of the item posted for sale or purchase via the auction. For example, in some embodiments, the seller may offer discounts, rebates, or other preferential status only on selected items, selected sets of items, or selected classes of items. This preferential status may be identified and applied via rules contained in transformation rule(s) 208.

As another example, in some embodiments, the application of a particular transformation function will depend on the nature or identity of the item posted for sale or purchase via the auction. For example, in some embodiments, a buyer may wish to only bid on a certain configuration of item. A configuration-related transformation function may be identified in 208 and may be applied when the particular item is offered for sale. For example, a buyer in a sell-side auction who has a desired configuration of a laptop computer may specify this by defining an appropriate transformation function. In an auction where laptop computers are offered for sale, the buyer's bid will be transformed to specify the desired configuration. Other examples of transformation rules will be provided below.

In the table depicted in FIG. 4, participant information is stored in participant database 200, which is stored at or accessible by auction administrator device 100. In other embodiments, participant information (or some portion thereof), may be stored at other locations, such as a database stored at or accessible to participant device 12 or auction service provider device 24 (FIG. 1). In such embodiments, participant information may be requested from the device that is storing or has access to the information, or it may be requested by other devices in the system.

In some embodiments, further participant information may be specified to precisely identify appropriate transformation functions. This information could include, for example, information specifying the nature of the participant, such as participant business, industry, demographic, and psychographic information. Other information may also be provided, such as information identifying participant purchasing behaviors, including: historical bidding information, click stream and other response information from other Web-sites or exchanges, and purchasing behavior from other sales and distribution channels.

Still other information may be provided identifying participants, such as transaction histories in other sales and distributions channels, or transaction histories for sales or purchases of goods or services unrelated to items being offered in the present auction. This information may include information related to the future cost of servicing a particular participant, such as warranty and other terms typically provided to the participant in these and other transactions. Yet other information may be provided which identifies participant behavior post-transaction, such as return rates or estimates of anticipated future transactions. Other information might also include information to ascertain the participant's level of interest in a particular item, such as historical responses to sales inquiries about the item, or feedback provided by sales representatives or customer service representatives about the participant. Those skilled in the art will recognize that other information may also be provided which may allow the creation, selection and application of appropriate transformation functions for a particular participant.

Auction Database

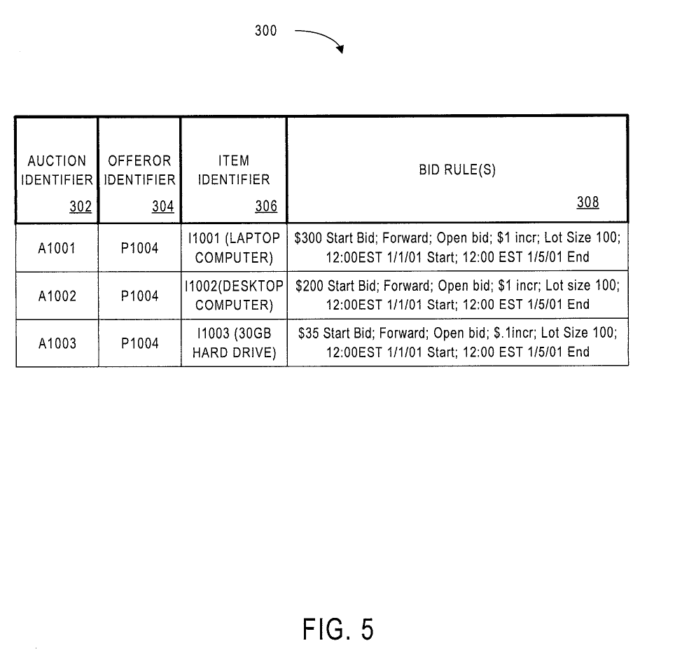

Referring now to FIG. 5, a table is shown representing an auction database 300 that may be stored at, or accessible to, auction administrator device 100 (FIG. 3) according to an embodiment of the present invention. The table includes a number of entries identifying one or more auctions that are operated by the auction administrator. The table also defines fields 302-308 for each of the entries. The fields specify information used to identify each of the auctions administered by the auction administrator, including for example: an auction identifier 302, a seller identifier 304, an item identifier 306, and one or more bid rule(s) 308. The information in auction database 300 may be created and updated, for example, when an auction administrator establishes an auction using features of embodiments of the present invention. This information may be entered by an auction administrator operating auction administrator device 100. In some embodiments, the information may also be entered by other parties, such as a participant operating participant device 12 or a service provider operating auction service provider device 24 (FIG. 1).

Auction identifier 302 may be, for example, an alphanumeric code associated with an auction administered by an auction administrator. Auction identifier 302 may be generated by, for example, auction administrator device 100.

Offeror identifier 304 may be, for example, the same as or related to participant identifier 202 of participant database 200. Offeror identifier 304 identifies the party in the auction identified by auction identifier 302 who is soliciting bids on an item. For example, in a sell-side auction, the offeror identifier 304 identifies a participant who has posted an item for sale via the auction identified by auction identifier 302. In a buy-side auction, on the other hand, the offeror identifier 304 identifies a participant interested in purchasing and item or items, and is soliciting bids from prospective sellers via the auction identified by auction identifier 302.

In some embodiments, offeror identifier 304 may identify an offeror that does not have a participant identifier (from participant database 200). In such cases, additional information identifying the offeror may be provided, for example, in auction database 300.

Item identifier 306 may be, for example, information identifying one or more items for which bids are being solicited in the auction identified by auction identifier 302. The information may include, for example, a product code such as a Universal Product Code (UPC) or other information particularly identifying the item(s). In the depicted embodiment, item identifier 306 simply includes an alphanumeric designator along with a brief description of the item. In other embodiments, further details of offered items may be specified to precisely identify items offered by auction. These details could include descriptions of product or service characteristics, images depicting a product or service, information about the manufacturer or provider of a product or service, information about delivery terms associated with a product or service, links to web pages with further information about the product or services, links to web pages with further information about the manufacturer or provider of a product or service, etc.

Bid rule(s) 308 may include information identifying one or more rules that govern the bidding process of the auction identified by auction identifier 302. For example, bid rule(s) 308 may include rules specifying a starting bid for the item, whether the auction is a forward or a reverse auction, whether the auction is public or private, whether bidding will be anonymous or not, the type of auction (e.g., open cry, sealed-bid, Dutch, English, etc.), a minimum bid increment, a start time, an end time, a reserve price, etc. In some cases, these rules may specify other databases or database fields with further information required to process the rule. For example, if a rule specifies that an auction is a private auction, it might include a reference to another database specifying qualified participants in the private auction. Other rules necessary to govern the conduct of the auction identified by auction identifier 302 may also be provided in bid rule(s) 308.

In the example data shown in FIG. 5, one seller (participant identifier P1004) is soliciting bids in three different auctions for three different items. Each of the auctions in which P1004 is soliciting bids are forward open cry auctions, with established starting bids and bid increments. Each auction also has specified starting and ending times.

Transformation Function Database

Referring to FIG. 6, a table represents a transformation function database 400 that may be stored at (or accessible to) auction administrator device 100 (FIG. 3) according to an embodiment of the present invention. The table includes a number of entries identifying different transformation functions that may be applied to information in auctions operated pursuant to embodiments of the present invention. The table also defines a number of fields 402-406 for each of the entries. The fields specify: a function identifier 402, transformation rule(s) 404, and a transformation description 406. The information in transformation function database 400 may be created and updated, for example, by an auction administrator based on information received from individual participants in an auction.

Function identifier 402 may be, for example, an alphanumeric code associated with a particular transformation function that may be used in an auction operated pursuant to embodiments of the present invention. A number of different function identifiers 402 may be established for use in an auction.

Transformation rule(s) 404 may be, for example, information identifying one or more rules that are applied when the transformation function identified by function identifier 402 is used. Transformation rule(s) 404 may include any of a number of different types of rules including rules that operate on the amount of an offer to purchaseor offer to sell, rules that operate on a bid or offer quantity or configuration, or the like. Examples of different types of transformation rule(s) 404 which may be applied using embodiments of the present invention include rules which: apply a discount; apply a rebate; factor in shipping; duties, and other logistics costs; factor in taxes; perform a currency exchange from an offer currency to an auction currency (or vice versa); establish a preferred configuration; establish a preferred quantity; establish preferred service levels; establish warranty terms; establish payment terms; establish desired ancillary services; establish required ancillary services; establish particular bundlings of goods or services; establish the utility associated with certain product or service attributes; establish a preferred shipping mode; establish a preferred shipping route; waive a fee; etc. These transformation rule(s) may be established for a particular participant (e.g., the rules may particularly define specific product bundling needs for a specific participant), or they may be generically created for multiple participants (e.g., currency conversion may always be applied in an auction to transform a buyer's local currency to the functional currency or default currency of an auction currency).

Transformation rule(s) 404 may be expressed in any of a number of different functional forms, including functions that operate on the amount of an offer to purchase or offer to sell, functions that operate on a bid or offer quantity or configuration, or the like. Examples of different types of functional forms for transformation rule(s) 404 which may be applied using embodiments of the present invention include functional forms such as: a fixed percentage multiplier of a bid, offer, or auction status; a percentage multiplier of a bid, offer, or auction status that varies with a quantity of said bid; a percentage multiplier of a bid, offer, or auction status that varies with a magnitude of a bid, offer, or auction status; a fixed addition to said bid price; a fixed addition to said bid price that varies with a magnitude of a bid, offer, or auction status; an amount added to the bid price that varies with a magnitude of a bid, offer, or auction status; a linear function; and a non-linear function.

In one embodiment of the present invention, transformation rule(s) 404 may be described in terms of a functional model, with associated model parameters. In such embodiments, entries in transformation function database 400 may include a transformation rule 404 describing the functional form of the transformation function, accompanied by at least one parameter associated with the transformational form. For example, a simple parameterized model to represent increasing a bid by 10% could be represented by the functional form “TRANSFORMED BID=PARAMETER*ORIGINAL BID”, with an associated parameter of “1.10”.

Transformation rule(s) 404 may include rules establishing that a discount or other transformation be performed only if certain conditions are met. For example, some transformations may only be available to participants dealing with a particular participant (e.g., a seller may grant a strategic partner discount to a particular buyer). Other transformations may only be available if the bid amount or other terms of bid meet specified criteria (e.g., a buyer may receive a discount if the offer to purchase amount is above a predetermined threshold). Those skilled in the art, upon reading this disclosure, will recognize that a number of other different types and combinations of transformation rule(s) 404 may be applied using features of the present invention.

Transformation description 406 may be, for example, information describing the function identified by function identifier 402. Further, information at 406 could include information to be displayed to participants of the auction during the auction.

As shown in FIG. 6, transformation functions pursuant to embodiments of the present invention include transformations of bids or offers (such as functions F1001-F1004) and transformations of auction status (such as functions F1005-F1006). Some transformations affect the amount (in currency or quantity, for example) of a bid, while other transformations may affect the configuration, style, quality, or other attributes of an item for which an offer is made (such as function F1007). Other transformations may affect a buyer or seller's registration status or participation terms in an auction (such as function F1008). Other transformations may affect multiple information sources and flows. For example, some transformation functions could affect bids and offers, as well as auction status. Other transformations may also be provided as will become apparent to those skilled in the art upon reading this disclosure.

Bid Database

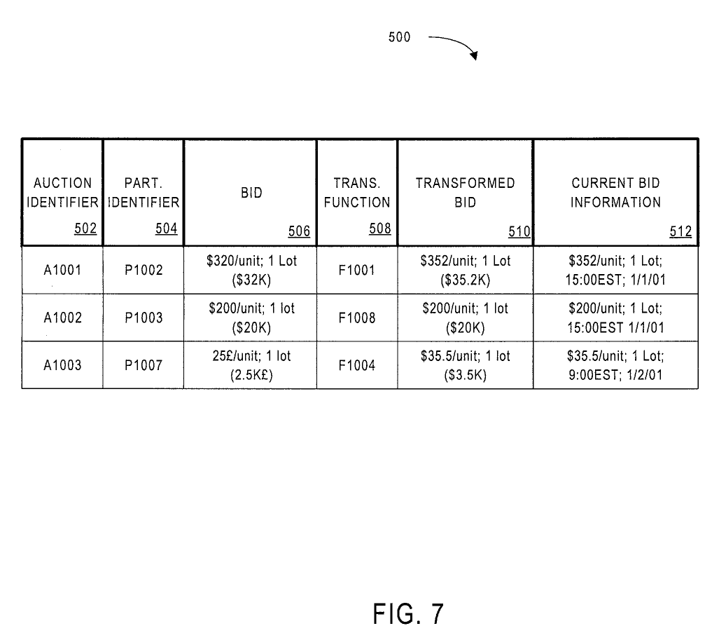

Referring now to FIG. 7, a table is shown which represents a bid database 500 that may be stored at, or accessible by, auction administrator device 100 according to an embodiment of the present invention. The table includes a number of entries identifying bids that have been received in auctions administered by an auction administrator operating auction administrator device 100. For clarity of exposition, only a few exemplary bids are illustrated in the table shown in FIG. 7. As described in the definitions set forth above, “bids” as used herein may refer to either offers to purchase or offers to sell (depending on the type of auction operated), therefore, bid database 500 may record information about offers to sell (e.g., in the case of a buy-side auction), offers to purchase (e.g., in the case of a sell-side auction), or both offers to purchase and offers to sell (e.g., in the case of a two-sided auction).

The table also defines a number of fields 502-512 for each of the entries. The fields specify: an auction identifier 502, a participant identifier 504, a bid 506, a transformation function 508, a transformed bid 510, and current bid information 512. The information in bid database 500 may be created and updated, for example, each time auction administrator 16 receives a bid from a participant in an auction being operated by auction administrator 16. Some or all of the information stored in bid database 500 may be received via communication network 18 in any of a number of different formats. For example, bids (and other information transmitted pursuant to the invention) may be submitted by (or to) participants 12 via electronic data interchange (EDI) messages, via Extensible Markup Language (XML) messages, via instant messaging, via electronic mail, via Web-based forms, via telephone or facsimile, telex, etc.

Auction identifier 502 may be, for example, based on or identical to auction identifier 302 of auction database 300, and is used to associate a particular bid with a particular auction. Each auction identified by an auction identifier 502 may have a number of entries representing individual bids received for that auction. In the table shown in FIG. 7, only the current best bid in each auction is shown. However, other bids and offers, including a previous best bid or bids, or current bids that are not the current best bid, could also be recorded in bid database 500. For example, in a continuous two-sided auction, a buyer may place a bid that at the time of the bid may not be the current best bid, but which may become the current best bid as market conditions change over time.

Participant identifier 504 may be, for example, based on or identical to a participant identifier 202 of participant database 200 and is used to identify a particular participant (such as a buyer or seller) in an auction. Each participant in an auction may submit multiple bids and, therefore, bid database 500 may contain multiple entries for a participant in a particular auction. In the example data depicted in FIG. 7, bid data is shown for three different participants (buyers P1002, P1003, and P1007) bidding in three different auctions (auctions A1001, A1002 and A1003).

Bid 506, may be, for example, information identifying a particular bid made by a participating buyer or seller. In the embodiment depicted, only information reflecting the current best bid in each auction is depicted. In some embodiments, data will also be stored indicating the bid history of the auction, including all bids received (whether or not a bid is the current best bid or not). The information in bid 506, in one embodiment, reflects non-transformed bid information. For example, referring to the first row of the table shown in FIG. 7, bid 506 made by participant P1002 is a bid to purchase one (1) lot of the item being auction in auction A1001 (reference to auction database 400 shows that item I1001—laptop computers—are the items being auctioned) at a bid price of $320/unit.

In some embodiments, there may be more than one current best bid or offer for each auction. For example, in some auctions, a single lot containing multiple items may be offered to multiple buyers. Bid database 500 may also be used to record former current best bids to provide a bid history or audit trail. For example, this information may be used to track the bidding history of different buyers and/or to award units being sold in the auction to a substitute buyer in the case where a current best buyer (or group of current best buyers) is unable to settle their auction trade. In some embodiments, bid database 500 may also be used to record current bids that are not the best bid.

Transformation function 508 may be, for example, the same as or related to one or more transformation function identifiers 402 of transformation database 400. For example, depending on the bid, the participant, and the auction, one or more transformation functions may apply. In the example data shown in FIG. 7, the bid made by participant P1002 is transformed by transformation function identifier F1001 (applying a 10% strategic partner credit). The bid made by participant P1003 in auction A1002 is transformed by the transformation function identified by identifier F1008 (waiving the auction registration fee), while the bid made by participant P1007 in auction A1003 is transformed by transformation function F1004 (converting currency from the bid currency to the auction currency in U.S. dollars). In the example date shown in FIG. 7, a single transformation function is associated with each entry. However, in some instances, there may be no transformation function associated with a bid by a participant in an auction, so there would be no entry in transformation function field 508 in bid database 500. In other cases, there may be multiple transformation functions associated with a single bid by a participant in an auction, so there would be multiple entries in transformation function field 508 in bid database 500.

Transformed bid 510 may be, for example, information reflecting bid 506 after application of transformation function 508. In the example data shown in FIG. 7, in the first row, the bid made by participant P1002 (of $320/unit) has been transformed by applying the 10% strategic partner credit to arrive at a transformed bid of $352/unit.

Current bid information 512, may be, for example, information identifying the current best bid in a particular auction. In a forward sell-side auction, the current best bid is the highest offer received. The best bid in a buy-side auction may be the lowest price offered for an item. Current bid information 512, may be, for example, information identifying a current status of the auction identified by auction identifier 502. The nature and content of this information may depend on the type of auction. For example, in a typical Open cry, forward, sell-side auction, current bid information 512 may include a current high bid amount and a current high bid quantity.

Other information necessary or useful in identifying a current bid status may also be provided in current bid information 512 (e.g., the time of the current bid may also be provided). In one embodiment, this current bid information 512 represents the current bid status at a particular moment in time (e.g., upon receipt and processing of the current bid received by the participant identified by participant identifier 504 in the auction identified by auction identifier 502).

In the data shown in FIG. 7, current bid information 512 reflects the current best bid in the auction. This current bid information 512 may be provided to participants to reflect the current status of the auction (e.g., informing potential participants of the current best bid). In some embodiments, as will be described further below, current bid information 512 may be further transformed before it is communicated to certain participants.

Those skilled in the art will recognize that other types of data may be included in bid database 500. For example, other types of information may be required in different types of auctions. A two-sided auction may require tracking limit orders and may also require tracking the expiration date and time of the limit orders. Other types of auctions may allow submission (and thus require tracking) of bids which are contingent on the occurrence or non-occurrence of some event. Other systems architectures are possible as well. For example, to improve system response times, historical bid information may be stored in a separate database.

Process

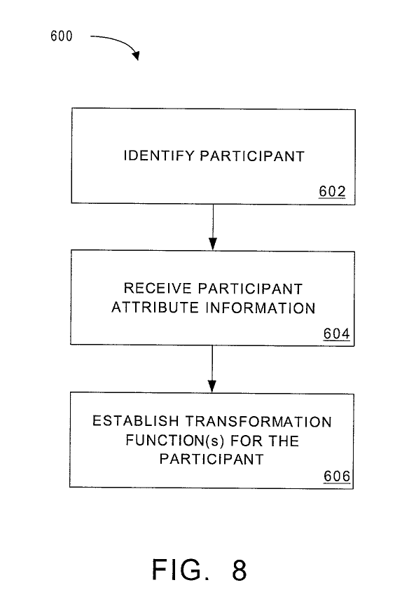

Processes pursuant to embodiments of the present invention will now be described by referring to FIGS. 8-11. In particular, a transformation binding process, a bid process, a transaction process, and a buy-side transaction process will be described. In one embodiment, the processes described in FIGS. 8-11 are conducted under the direction of computer program code stored at auction administrator device 16, participant device 12 and/or auction service provider device 24 (or any combination thereof). The particular arrangements of elements in the flow charts of FIGS. 8-11 are not meant to imply a fixed order to the steps; embodiments of the present invention can be practiced in any order that is practicable.

Transformation Binding Process

Referring now to FIG. 8, a transformation binding process 600 pursuant to one embodiment of the present invention is shown. Transformation binding process 600 may be performed using devices of system 100 (FIG. 1) to establish one or more transformation functions for a participant, so that the participant may take part in auctions conducted using features of the present invention. As an example, process 600 is a transformation binding process for a buyer, involving interaction between a buyer operating buyer device 12a-i and an auction administrator operating auction administrator device 16 via a communication network 18 such as the Internet. As another example, process 600 is a transformation binding process for a seller, involving interaction between a seller operating seller device 12n-z and an auction administrator operating auction administrator device 16.

In some embodiments process 600 occurs during a participant registration process. In other embodiments, process 600 is conducted separately to establish transformation functions for particular participants. In some instances, such transformation functions may apply only to a single auction, while in other instances such transformation functions may be utilized in multiple auctions. In some embodiments, process 600 may establish transformation functions that apply to groups or classes of participants, rather than individual participants. In some embodiments, transformation functions established by process 600 apply to all bids made by a participant. In other embodiments, process 600 establishes one or more transformation functions intended for use with one or more particular bids by a participant or set of participants.

Process 600 begins at 602 where the participant is identified. This identification may involve the participant providing information used to populate, for example, participant database 200 (FIG. 4). For example, processing at 602 may involve prompting the participant to enter basic information about itself, including contact information, a participant name, etc.

The participant may be identified by any of a number of other techniques as well. For example, a participant interacting via e-mail may be identified by its e-mail address. A participant interacting via a Web-site may be identified by a user name, and the participant's identity may be authenticated using a password verification process. Participants may also be identified by an identification number, such as an account number, a credit or debit card number, or a social security number. For XML and EDI transactions, the participant could be identified by fields located within XML or EDI messages. Participants interacting via facsimile or telephone may be identified using information about the originating telephone number. Participants could also be identified using cookies stored on a participant device 12.

Once the participant has been identified at 602, processing continues to 604 where participant attribute information is received. This attribute information is used to generate, select, or otherwise establish transformation function(s) for the participant. Participant attribute information may include any information useful or necessary to establish one or more transformation functions for the participant. For example, information received at 604 may include: a preferred currency of the participant; information specifying whether the participant has a particular relationship with one or more other participants (e.g., as a preferred customer of one or more sellers, etc.); information specifying a preferred configuration of one or more items; etc. Information may also be identified specifying a credit history or other details regarding the participants purchasing history.

Information received at 604 may also include logistics information for a particular participant, such as anticipated shipping costs, duties, excise taxes, value-added taxes, sales taxes, expediting fees, handling charges, service charges, or the like. Information received at 604 may also include information identifying demographic, psychographic, business, or industry attributes of the participant. Other information may also be received, including information identifying required or preferred service levels, information about the economy, information about certain supply chain status, warranty terms, payment terms, preferred shipping mode, preferred shipping route, shipping payment terms, financing terms, and other ancillary terms and conditions or services required or preferred by a particular participant.

In one embodiment, this information may be solicited using a series of registration questions that are presented to the participant for response. For example, in embodiments where the participant is operating a participant device and interacting with auction administrator device via the Internet, this information may be solicited by presenting the participant with a set of forms for entry and/or a checklist of options that may be selected by the participant. Other methods of soliciting and collecting information may also be used to establish transformation function(s). For example, third party databases may be accessed to collect some information. Such third party databases may include, for example: credit service bureaus, banks, rating agencies, insurance companies, medical agencies, check processing agencies, advertising agencies, motor vehicle departments, census bureaus, credit card agencies, governmental bodies, non-governmental organizations, non-profit organizations, or the like.

Once attribute information has been received at 604, processing continues to 606 where one or more transformation functions are established for the participant. Transformation functions may be established in any of a number of different ways. For example, an auction administrator operating auction administrator device 16 may establish a set list of transformation functions and qualifications for those functions. In such an embodiment, processing at 606 may simply involve matching the established transformation functions with participant attribute information received at 604 to identify those functions that apply to a particular participant. For example, the auction administrator may determine that only participants who have a long and active bidding history are eligible for a transformation function that allows a participant to receive reduced auction fees. A participant who qualifies for this particular transformation function may be associated with the transformation function by, for example, storing information that is accessible to auction administrator device 100 that associates the function identifier 402 in transformation function database 400 (FIG. 6) with the participant identifier 202 in participant database 200 (FIG. 4).

In some embodiments, transformation function(s) for a particular participant may depend on a relationship the participant has with another participant. For example, a buyer who has a preferred customer status with a seller may be eligible to receive a discount on items offered by that seller. Processing at 606 may include the identification of such relationships and such transformation functions. Again, the participant and the transformation function may be associated with each other by storing information accessible to auction administrator device 100 (e.g., by storing the relevant information in participant database 200 or in some other data store).

Processing at 606 may include the establishment of a new transformation function as well. For example, a seller may give a unique discount to a particular buyer. This unique discount may be defined in transformation function database 400 (FIG. 6) and associated with the appropriate participant. Processing at 606 may also include the establishment of transformation functions by the participant. For example, a buyer may construct a transformation function that defines a particular configuration of an item that the buyer desires (e.g., a buyer who has a particular laptop computer configuration requirement may define this configuration in one or more transformation functions created at 606).

Processing at 606 may result in multiple transformation functions being created which apply to one or more participants. The transformation functions may also be defined by different entities. For example, a particular buyer may establish a transformation function which defines a desired product configuration, while a seller may define a transformation function which grants the buyer a preferred customer discount. An auction service provider may define a transformation function for the same buyer participant that defines logistics information (such as shipping preferences) for that participant. Each of these different transformation functions could be applied to a single bid made by the buyer.

Those skilled in the art, upon reading this disclosure, will recognize that other techniques may be used to establish transformation functions for use in embodiments of the present invention.

Bid Process

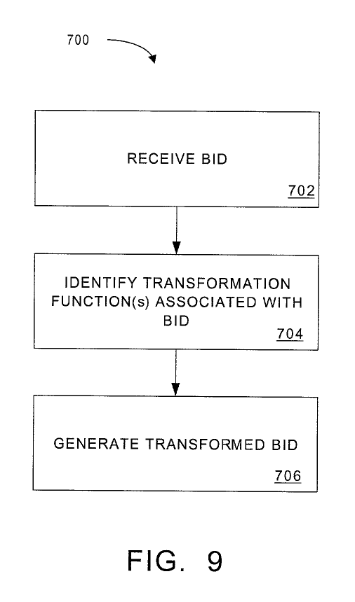

Referring now to FIG. 9, a bid process 700 pursuant to one embodiment of the present invention is shown. In one embodiment, bid process 700 is performed after an auction has been established for one or more items. In one embodiment, a participant may act as a buyer in the auction after one or more transformation functions have been established (e.g., via the transformation binding process 600 described in FIG. 8 above). In some embodiments, bid process 700 and transformation binding process 600 are performed during a single session. In one embodiment, bid process 700 is conducted under the direction of auction administrator device 16.

Processing begins at 702 where a bid is received. In one embodiment, the bid is received by auction administrator device 16 from a buyer operating buyer device 12a-i. Typically, the bid is received from the buyer after the buyer has had the opportunity to view the terms and conditions of the auction and read a description of the item(s) being offered in the auction. Further, unless the auction is of the sealed bid type or multiple-unit type, the buyer has also typically determined that it is willing to beat the current best bid on the item. In one embodiment, buyer device 12a-i transmits the bid to auction administrator device 16 over a network such as the Internet. Further, in one embodiment, the buyer views information about the auction by directing a Web-browser to an Internet site maintaining information about the auction.

The bid received at 702 may include information identifying the particular auction in which the bid is made, as well as information identifying the item bid on. The bid also typically includes terms of the bid such as a price term, a quantity term, a configuration term, and a delivery term.

Processing continues at 704, where one or more transformation functions associated with the bid received at 702 are identified. In one embodiment, one or more transformation functions are identified by auction administrator device 16 (e.g., by retrieving information contained in, for example, participant database 200, and/or transformation function database 400). A number of different techniques may be used to identify one or more transformation functions associated with a bid. Transformation functions may be identified based on: an identity of the buyer, an identity of the seller (or a relationship between the seller and the buyer), information about the seller, information about the item, information about the status of the auction, information about prices for comparable items in other markets, bidding history in the current auction, bidding histories in other auctions, and/or characteristics of the bid.

In some embodiments, bids or buyers (or sellers) may be associated with multiple transformation functions. In such cases, the transformation function(s) to be applied may be identified based in part on the other specified transformation function(s). For example, a buyer entitled to receive a special discount may not simultaneously be entitled to a volume discount credit. As another example, a buyer who has achieved a volume discount target may be entitled to application of a transformation function that waives an auction fee. In some cases, a transformation function associated with a bid may be identified based on a transformation function associated with a status request by the buyer (e.g., where the bid transformation function is the inverse of the status request transformation function). In some embodiments, a status request transformation function may be identified based on a bid transformation function. Transformation functions may also be identified and applied using combinations of any of the above factors.

In some embodiments, processing at 704 may involve checking multiple sources to identify relevant transformation function(s). For example, processing at 704 may simply involve a search for transformation functions accessible to auction administrator device 16, or it may involve a search for transformation functions at auction administrator device 16, participant device 12 and/or auction service provider device 24. Other sources of transformation functions may also be provided.

Once one or more transformation functions have been identified at 704, processing continues at 706 where a transformed bid is generated. This transformation may involve applying one or more transformation functions to the bid received at 702. In some embodiments, the transformation may require reference to extrinsic data. For example, a transformation function which requires conversion from one currency to another may involve reference to an external source of foreign exchange rate data. This reference may be performed in conjunction with processing at 706.

Once the bid has been transformed, the transformed bid is presented to the auction as the buyer's bid. The transformed bid is then considered pursuant to the auction rules. For example, in a forward English auction, the transformed bid will be compared with the current best bid to determine if the transformed bid is greater than the current best bid. If it is, then the transformed bid becomes the auction's current best bid, and any subsequent bid must be greater than the transformed bid to be successful. In this manner, embodiments of the present invention permit a buyer's special circumstance to be factored into the buyer's bid.

Transaction Process

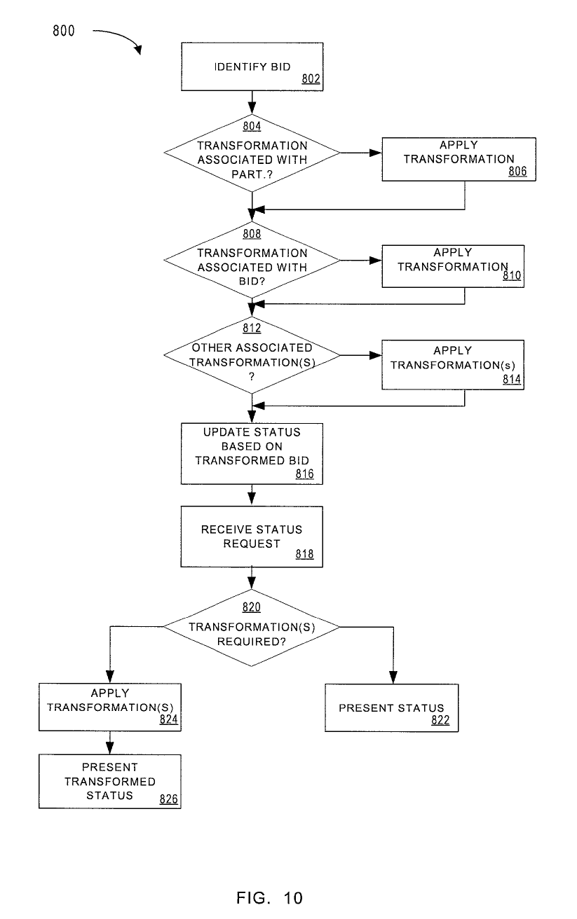

Referring now to FIG. 10, an example transaction process 800 pursuant to an embodiment of the present invention is shown. Transaction process 800 depicts a typical process that may occur in auctions implementing features of the present invention. Process 800 describes a process where one participant in an auction submits a bid and the bid is transformed and used to update a status of the auction. A second participant then checks the status of the auction. The auction status may then be transformed for viewing by the second participant.

Transaction process 800 begins at 802 where a bid is identified. For example, at 802, auction administrator device 16 (FIG. 1) may receive a bid on an item in an auction from a buyer operating a buyer device 12. The bid identified at 802 may include information identifying the particular auction in which the bid is submitted, the buyer (or seller), as well as bid information such as a bid price and a bid quantity, etc.

At 804, processing determines whether a transformation function is associated with the buyer who submitted the bid identified at 802. According to embodiments of the present invention, certain transformation functions may be identified based on an identity of the buyer. For example, a particular buyer may be entitled to a preferred partner discount in certain situations. If processing at 804 indicates that a transformation function based on the buyer's identity exists, processing continues to 806 where the transformation function is applied to the bid. Processing then continues to 808. If processing at 804 indicates that no transformation function exists which is based on the buyer's identity, processing continues to 808.

At 808 a determination is made as to whether any transformation function(s) associated with the bid identified at 802 exist. In some embodiments, one or more transformation functions may be identified based on information in a bid. For example, an auction may specify that a bid for a large quantity of items may receive a quantity discount. In this example, processing at 808 checks to determine if the bid is for a sufficiently large quantity of items to qualify for the quantity discount. Other types of transformation functions based on the bid may also be identified. If processing at 808 identifies one or more transformation functions based on the bid, processing continues to 810 where the bid is further transformed by the transformation function(s) identified at 808. Processing then continues to 812. If processing at 808 does not identify any transformation functions based on the bid, processing continues at 812.

Processing at 812 includes a determination of whether any other transformation function(s) are associated with the bid identified at 802. That is, processing at 812 involves determining if there are any transformation function(s) not associated with the buyer or the bid. For example, in some embodiments, a transformation function may be identified based on the item offered at auction and/or information about the balance between supply and demand for the item. For example, if the seller is offering different configurations of an item at auction and certain configurations are exhibiting high demand, then transformations associated with those configurations may be adjusted accordingly.

Processing at 812 may also involve identifying one or more transformation functions based on the seller of the item. For example, if a bid is being translated into the currency of a buyer, the transformation may require the determining the functional currency of the seller in order to properly perform the conversion. Processing at 812 may involve interactions between transformations applied at 804, 808, and/or other functions applied at 812.

In some embodiments, processing at 812 may also include the application of transformation functions used to preserve the integrity of the auction. For example, a transformation function intended to ensure that bidding always monotonically increases in a forward English auction may be applied at 812. Transformation functions identified at 812 may also be identified based on information from the auction service provider (e.g., where the service provider is acting as a logistics provider, settlement entity, or otherwise providing services to enhance the value of the item, or to facilitate transactions for the item).

Processing at 816 includes updating a status of the auction based on the transformed bid. Depending on the number and type of transformation functions identified at 804, 808 and 812, the transformed bid may be significantly different than the original bid identified at 802. In some embodiments, the transformed bid may be slightly changed (or even remain unchanged) from the original bid identified at 802. According to embodiments of the present invention, this transformation process and use of a transformed status allows differently situated participants to compete in the same auction.

In a typical auction, once a bid has been received and the auction status has been updated to reflect the current best bid, other potential buyers and participants in the auction will request a status of the auction. This remains unchanged in auctions conducted pursuant to embodiments of the invention. As shown in FIG. 10, a status request is received at 818. Unlike previous auctions, however, processing pursuant to embodiments of the present invention includes a determination of whether transformation(s) of the status of the auction are required (step 820). According to embodiments of the present invention, the status of the auction may be transformed to present a transformed status to some participants. Other participants may view non-transformed status.

According to embodiments of the present invention, processing at 820 includes making a determination of whether one or more transformations of the auction status are required. This determination may occur in any of a number of ways. For example, in some embodiments, the status request received at 818 may include an identification of the participant requesting the status. This information may be used to determine if a transformation function should be applied. Further, information about the auction and the item(s) being auctioned may also be used to determine if a transformation function should be applied. As an example, referring to participant database 200 (FIG. 4), if participant P1004 is the participant requesting status at 818, processing at 820 may involve a search of participant database 200 which will identify that participant P1004 is associated with transformation functions F1006 (“Display Status for Strategic Partners”). Note that in participant database 200, participant P1004 is also associated with transformation function F1001 (“Increase Bid by 10%). However, since transformation function F1001 is associated with a bid and not a status request, it will not be identified at 820. Although they are not described in this example, other transformations not recorded in participant database 200 (FIG. 4) may be identified at 820 based on P1004's bid, the item at auction, or other factors described herein.

Once a determination has been made that transformation(s) of the status are required, processing continues to 824 where the transformation(s) are applied to the status. In the example where the status request is issued by participant P1004, processing at 824 involves applying transformation function F1006 to the current status of the auction. If the current status of the auction is that the current best bid is a $10,000 bid, then the transformed status generated at 824 will be that the current best bid is a $9,000 bid. This transformed status is presented to the requesting party at 826. Presentation of the transformed status may be accomplished in any of a number of different ways such as, for example using XML or EDI transactions, instant messaging, e-mail, a Web-page, a telephone, facsimile, telex, etc.

In some embodiments of the present invention, only the transformed status will be presented to the buyer or seller at 826. In other embodiments, however, both the transformed status and the untransformed status may be presented. In yet other embodiments, the transformed status may be presented in conjunction with a partially transformed status reflecting transformation by only a subset of the transformation functions that apply to the status request. In some embodiments, information about the transformation function applied to the status request is presented to the participant, while in other embodiments, no information about the transformation function applied to the status request is presented to the participant. In yet other embodiments, various combinations of transformed, partially transformed, or untransformed status information is presented, with or without information about the associated transformation functions.

If processing at 820 indicates that no transformation of status is required, processing continues to 822 where the status is presented to the requester. This non-transformed status may be presented in any of a number of different ways, such as, for example, using XML or EDI transactions, instant messaging, e-mail, a Web-page, a telephone, facsimile, telex, etc.

According to embodiments of the invention, transaction process 800 may be performed a number of times during an auction. The result is a system that allows personalization of bids (including offers to purchase and offers to sell), and auction status information based on each participant's particular situation. As a result, differently-situated participants may take part in a single auction, with the bidding in the auction and presentation of auction status transformed to reflect their particular situations.

Buy-Side Transaction Process

Embodiments of the present invention may be used in the conduct of auctions commonly known as “buy-side” auctions where a number of potential sellers interact with one buyer of an item (or items). According to embodiments of the present invention, one or more of the potential sellers may be associated with one or more transformation functions that may be used to transform their offers and/or to transform their view of the status of the auction. Further, the buyer may also be associated with one or more transformation functions that may be used to transform the buyer's view of offers received and the auction status.

As a result, buy-side auctions may be operated which allow many differently-situated sellers to compete against each other to sell items via auction to a buyer. Embodiments of the present invention permit this competitive process to occur even where the item being sold at auction is non-standardized (e.g., where different sellers are attempting to sell items having different configurations, different characteristics, and different bundled services to the buyer). From the perspective of each of the sellers, the auction is conducted in the fashion of a normal buy-side auction, however, processing pursuant to embodiments of the present invention functions to transform certain offers and status requests to translate the information in the auction, thereby adapting to the individual circumstances of the various participants in the auction. The buyer enjoys the benefit of active competition among these different sellers, thus receiving better prices on items purchased in the auction.

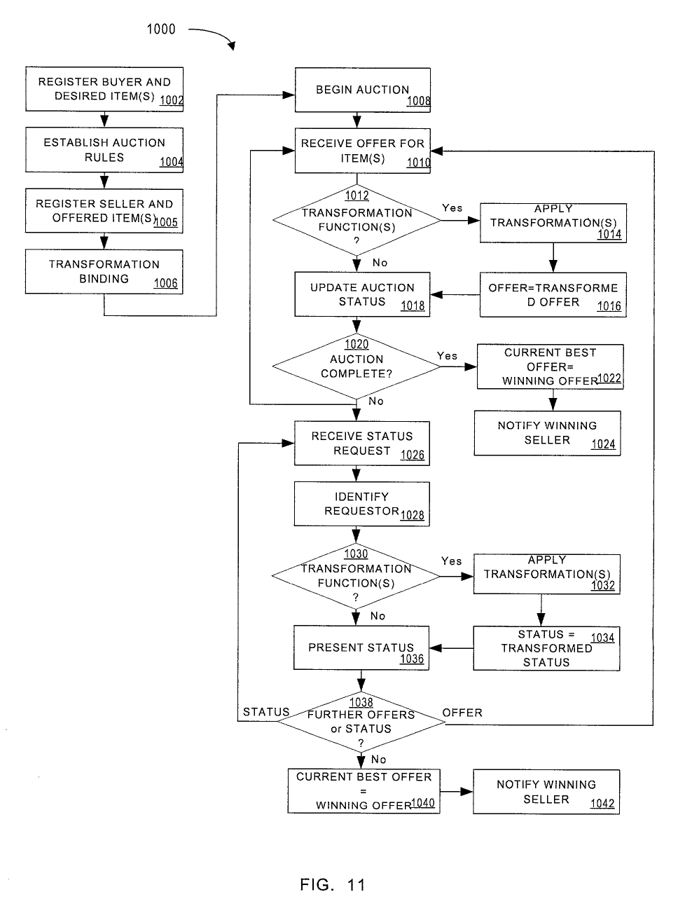

An example of a buy-side auction conducted using features of embodiments of the present invention will now be described by referring to FIG. 11. FIG. 11 depicts a process 1000 for conducting a buy-side auction pursuant to embodiments of the present invention. In one embodiment, buy-side auction process 1000 begins at 1002 where a buyer registers to acquire one or more items in an auction. A buyer may register to purchase items in more than one auction. Registration at 1002 may involve interaction over a network between a buyer operating participant device 12 and an auction administrator operating auction administrator device 16 (FIG. 1). In some embodiments, registration at 1002 may involve interaction with an auction service provider operating service provider device 24 (FIG. 1). This registration may involve the buyer providing information identifying itself and information identifying the item(s) to be acquired in the auction. This information may be stored in databases located at or accessible to auction administrator device 16, participant device 12 or service provider device 24 (perhaps depending on which party is operating the auction). In some embodiments, processing at 1002 may also include the identification and/or establishment of one or more transformation functions associated with the buyer. In other embodiments, any relevant transformation functions are established in conjunction with transformation binding 1006, described below.

Once the buyer has registered to conduct the auction, processing continues at 1004 where auction rules are established. Some or all of the rules of the buy-side auction may be established jointly between the buyer and the auction administrator. In one embodiment, this information is stored at auction administrator device 16 (e.g., in auction database 300).

Processing continues at 1005 where a seller registers to sell one or more items in an auction. Registration at 1005 may involve interaction over a network between a seller operating participant device 12 and an auction administrator operating auction administrator device 16 (FIG. 1). In some embodiments, registration at 1005 may involve interaction with an auction service provider operating auction service provider device 24 (FIG. 1). This registration may involve the seller providing information identifying the seller and information identifying the item(s) to be sold in the auction. This information may be stored in databases located at or accessible to auction administrator device 16, participant device 12 or service provider device 24 (perhaps depending on which party is operating the auction). In some embodiments, processing at 1005 may also include the identification and/or establishment of one or more transformation functions associated with the seller. In other embodiments, any relevant transformation functions are established in conjunction with transformation binding 1006, described below.

Processing continues at 1006 where a transformation binding process is conducted. Processing at 1006 may be conducted as described above in conjunction with FIG. 8. In general, processing at 1006 establishes one or more transformation functions associated with one or more participants in the buy-side auction. Transformation functions may be generated, identified, and/or associated with one or more sellers, the buyer, the auction service provider (if any), and the auction administrator at 1006. In some embodiments, the binding process occurs prior to, or in conjunction with, the registration of the buyer or sellers. In other embodiments, some or all of the binding process occurs during the conduct of the auction (e.g., before a new seller makes an offer to sell an item in the auction, it may be required to go through a binding process similar to the process described in conjunction with FIG. 8). Transformation functions established at 1006 may be associated with sellers in a database, such as, for example, participant database 200 (FIG. 4). Transformation functions may be defined in a database such as, for example, transformation function database 400 (FIG. 6).

Processing continues at 1008 where the auction commences pursuant to the auction rules established at 1004. Commencement of the auction may involve some notification of potential sellers of the start of the auction.

Processing continues at 1010 where an offer to provide an item or items requested in the buy-side auction is received. This offer may be received in any of a number of different ways known in the art. In one embodiment, the offer is received via an auction Web-page. The offer preferably includes information identifying or associated with the seller making the offer. The offer will also include information identifying terms of the offer, such as an offer price and quantity. Other information may also be provided, such as shipping terms, configuration terms, etc.

Some or all of the information received with the offer at 1010 is used at 1012 to identify if any transformation function(s) should be applied to the offer. Identification of any transformation function(s) associated with an offer may occur at 1012 as described above in conjunction with the bid process of FIG. 9. Identification of any transformation function(s) associated with a seller may occur at 1012 as described above in conjunction with step 1002, step 1005, or step 1006. For example, if a bid is being translated into the currency of the buyer, the transformation may require the determining the functional currency of the seller in order to properly perform the conversion.

In addition, other transformation function(s) may be identified at step 1012 that are associated with neither the offer nor the seller, as described above. Furthermore, other transformations may be identified at stop 1012 that define transformations on transformation functions, as described above. In some embodiments, processing at 1012 may also include the application of transformation functions used to preserve the integrity of the auction. For example, a transformation function intended to ensure that bidding always decreases in a reverse English auction may be applied at 1012. Transformation functions identified at 1012 may also be identified based on information from the auction service provider (e.g., where the service provider is acting as a logistics provider, settlement entity, or otherwise providing services to enhance the value of the item, or to facilitate transactions for the item).

If one or more transformation functions are identified at 1012, they are applied to the offer at 1014 to generate a transformed offer at 1016. This transformed offer is then used to update the status of the auction at 1018. If no transformation functions are identified at 1012, processing continues directly to 1018 and the buy-side auction status is updated to reflect receipt of the offer received at 1010. According to embodiments of the invention, appropriate transformation of certain offers allows participants with different situations to evenly participate in the same buy-side auction. Updating the auction status at 1018 may involve storing bid data in a database such as bid database 500 (FIG. 7).

A determination may be made at 1020 of whether the auction is complete (e.g., by checking if the auction end time has passed). If processing at 1020 indicates that the auction is complete, processing may continue to 1022 where the current best offer becomes the winning offer of the auction. The winning seller is then notified at 1024 using any of a number of techniques known in the art.

Returning again to step 1020, if the auction continues, processing may either revert to 1010 (if a further offer to sell is received) or proceed to 1026 where a status request is received. A status request may be any indication received from an entity requesting a status of the auction. Typically, buyers in the auction will request information about the status of the auction so that they can make a decision as to whether or not to solicit additional bids for items, or to increase or decrease the lot size for items that have already been put up for bid. Buyers may also request information about the status of the auction to determine which transformation functions, if any, to apply to new sellers entering the auction, or to bind to existing sellers in the auction. Sellers may issue status requests to identify the current auction price of the offer, perhaps to determine whether or not additional bids should be placed In addition, auction service providers may issue status requests to determine which services, if any, might be required by the current best seller should he win the auction. Auction service providers may also issue status requests to determine which services, if any, might be required by the current buyer should the auction close. Auction status information might also be used by an auction service provider to determine which transformations function, if any, to offer to new sellers or buyers entering the auction, or to bind to existing sellers or buyers in the auction. Auction status information might also be used by auction participants, auction service providers, auction administrators, and third parties to discover, monitor, transfer, and record the prices of goods or services offered for sale at the auction or marketplace.

For example, a potential seller operating participant device 12 may direct a Web-browser on device 12 to a Web-site hosted by auction administrator 16 to provide information on the on-going buy-side auction. The status request of 1026 may be a request to view an auction status Web-page at the Web-site hosted by the auction administrator. Any of a number of other types of requests for status may also be used.

Upon receipt of the request for status of the auction, processing continues at 1028 where the party requesting the status is identified. This may be performed in any of a number of different ways known in the art (e.g., by asking for identification, by detecting an identification code stored in a cookie on the requestor's device, etc.). Once the requestor has been identified, processing continues to 1030 where a determination is made as to whether one or more transformation function(s) should be applied to the request for status. According to embodiments of the present invention, status information for a buy-side auction may be transformed in certain situations (e.g., based on an identity of the requester, the item being auctioned, or other conditions). A number of types and situations in which such transformations may be used to transform an auction status are described above.

If processing at 1030 indicates that one or more transformation functions should be applied to the status, processing continues to 1032 where the transformations are applied to generate a transformed status at 1034. The transformed status is then used as the auction status presented to the requestor at 1036. If processing at 1030 does not identify any relevant transformation functions to be applied, processing passes directly to 1036 where the status presented to the requester is the actual, non-transformed status of the auction. In this manner, buy-side auctions operated pursuant to embodiments of the present invention allow differently-situated participants in the auction to view the auction status based on their own particular situation, allowing them to make auction participation decisions based on information adapted to their individual circumstances.

Processing continues at 1038 where a check is made to determine if any further offers have been made or if any further status requests have been made. Processing continues in this state until a further offer is received, a further status request is made, or the auction ends. If a further offer is made, processing reverts to 1010 and the process described above repeats. If a further status request is received, processing reverts to 1026 and the process described above repeats from that point. If processing at 1038 indicates that no further offers are made, and a determination is made that the auction is complete, processing may continue to 1040 where the current best offer becomes the winning offer of the auction. The winning seller is then notified at 1042 using any of a number of techniques known in the art.

Although the present invention has been described with respect to a preferred embodiment thereof, those skilled in the art will note that various substitutions may be made to those embodiments described herein without departing from the spirit and scope of the present invention. The particular transformation functions specified and described herein have been selected for clarity of exposition, and do not represent all possible transformations. The stage at the auction process during which transformation functions are associated or bound with a bid or buyer or seller submitting the bid, or other entity as specified and described herein have been selected for clarity of exposition, and do not represent all possible auction stages when transformations could be associated or bound.

The manner in which transformation functions are associated with a bid or buyer or seller submitting the bid, or other entity, as specified and described herein have been selected for clarity of exposition, and do not represent all possible manners by which transformations could be associated or bound. Those skilled in the art will also note that although embodiments of the present invention have been described in the context of an auction or marketplace, certain features or embodiments may also apply to other forms of commerce and electronic commerce, including electronic negotiation, combinations of auctions and electronic negotiation, and various forms of interactions between and among various agents, including business entities, individuals, data processing systems, auctions, marketplaces, and intelligent software agents.

What is claimed is:

1. A method for facilitating the acquisition of an item by a buyer in an auction involving a plurality of sellers, comprising:
defining a plurality of transformation functions available for use in said auction;
identifying an offer to sell said item, said offer made by one of said plurality of sellers;
selecting, based at least in part on said offer or said seller, at least one of said plurality of transformation functions;
applying said selected transformation function to said offer to produce a transformed offer; and
updating a state of said auction based on said transformed offer.

2. The method of claim 1, further comprising:
determining if said transformed offer is a winning offer of said auction; and
notifying said seller and said buyer of said winning offer.

3. The method of claim 1, further comprising:
generating status data representing said state of said auction.

4. The method of claim 3, further comprising:
receiving a status request;
selecting a second transformation function based on said status request; and
applying said second transformation function to said status data to produce a transformed status.

5. The method of claim 4, wherein said second transformation function is at least one of: a function which is the inverse of said transformation function over some range of said transformation function; a function which is dependent on said transformation function; and a function which is independent of said transformation function.

6. The method of claim 4, wherein said status request is received from one of said plurality of sellers.

7. The method of claim 1, further comprising:
identifying at least a third transformation function associated with said offer; and
wherein said applying includes applying both said transformation function and said at least third transformation function to said offer to produce said transformed offer.

8. The method of claim 7, wherein said at least third transformation function is identified based on at least one of: said item, said seller, said offer, and said transformation function.

9. The method of claim 1, wherein said transformation function is comprised of a plurality of intermediate transformations.

10. The method of claim 9, wherein said plurality of intermediate transformations are based on at least one of: said bid, said offer, said buyer, said seller, said item, an identity of said seller, an identity of said buyer, a relationship between said buyer and said seller, information about said buyer, information about said seller, information about said item, information about the state of said auction, information about prices for items comparable to said item in other markets, information about the status of a supply chain, information about economy conditions, information about demand and supply balance, a bid history in said auction, an offer history in said auction, a bid history in a second auction, an offer history in a second auction, information about commercial transactions conducted by said buyer, information about commercial transactions conducted by said seller, information about sales or purchase behaviors of said buyer, information about sales or purchase behaviors of said seller, rules about the composition or interaction of transformation functions, rules about the conduct of said auction, a characteristic of said bid, and a characteristic of said offer.

11. The method of claim 9, wherein each of said intermediate transformations are applied in a sequence.

12. The method of claim 1, wherein at least one of said receiving an offer, said identifying a transformation function, and said applying said transformation function are performed by a seller computing device operated by said seller.

13. The method of claim 1, wherein at least one of said receiving an offer, said identifying a transformation function, and said applying said transformation function are performed by a service provider computing device operated by a service provider.

14. The method of claim 1, wherein at least one of said receiving an offer, said identifying a transformation function, and said applying said transformation function are performed by an auction administrator computing device operated by an auction administrator.

15. The method of claim 1, wherein said receiving an offer, said identifying a transformation function, and said applying said transformation function are each performed by an auction administrator computing device operated by an auction administrator, by a seller computing device operated by said seller, or by a service provider computing device operated by a service provider.

16. The method of claim 1, further comprising:
determining if said transformed offer is the current best offer of said auction; and
updating a state of said auction to indicate that said transformed offer is the current best offer.

17. The method of claim 1, further comprising:
verifying the accuracy of said transformation function.

18. The method of claim 1, further comprising:
verifying the accuracy of said transformation function; and
updating a state of said auction to indicate that said transformed offer is the current best offer.

19. The method of claim 1, further comprising:
receiving at least a second offer to sell said item from a second seller;
comparing said second offer to said transformed offer to determine if said transformed offer or said second offer is the current best offer; and
updating a state of said auction to identify the current best offer.

20. The method of claim 1, further comprising:
awarding said item to said seller for the terms set forth in said offer if said transformed offer is the current best offer at an end of an offer period for said item.

21. The method of claim 1, wherein said offer includes at least one of: an offer price; an offer quantity; and a desired configuration.

22. The method of claim 21, wherein said transformation function modifies at least one of said offer price, said offer quantity, and said desired configuration.

23. The method of claim 1, wherein said transformation function includes at least one parameter whose value is determined based on data extrinsic to said auction.

24. The method of claim 23, wherein said at least one parameter includes at least one of: a foreign exchange rate; a shipping rate; an interest rate; an amount about the auction; a number about the supply chain status; and a market price of a component of said item.

25. The method of claim 1, wherein said auction is at least one of: an English auction, a Dutch auction, a Japanese auction, a sealed-offer auction, a double auction, a multiple-unit auction, a time interval auction, a call auction, a first price auction, a uniform second price auction, a combinatorial auction, and a multi-attribute auction.

26. A method for conducting an auction involving a plurality of sellers competing to provide an item to a buyer, comprising:
defining a plurality of transformation functions available for use in said auction;
receiving a request for a status of said auction from a seller;
selecting, based at least in part on said request for status, at least a first one of said plurality of transformation functions;
applying said at least first transformation function to said status to generate a transformed status; and
presenting said transformed status to said seller.

27. A method for facilitating the sale of an item to a buyer in a buy-side auction involving a plurality of sellers, comprising:
establishing a plurality of transformation functions available for application in said buy-side auction;
receiving, from a first seller, an offer to sell said item;
selecting, based at least in part on said offer, a first transformation function from said plurality of transformation functions;
applying said first transformation function to said offer to generate a transformed offer;
updating a status of said buy-side auction to reflect said transformed offer;
receiving, from a second seller, a request for a status of said buy-side auction;
selecting, based at least in part on said request, at least a second transformation function from said plurality of transformation functions;
applying said at least second transformation function to said request to generate a transformed status of said buy-side auction; and
presenting said transformed status to said second seller.

28. A method for participating in an auction involving a plurality of sellers and at least one buyer of an item, comprising:
registering to participate as a seller in said auction; and
establishing at least a first transformation function for use in said auction.

29. The method of claim 28, further comprising:
submitting an offer to sell said item, said offer operated on by said at least first transformation function to create a transformed offer; and
receiving a status of said auction, said status reflecting said transformed offer.

30. An auction registration method, comprising:
receiving information identifying a seller; and
establishing, based at least in part on said information identifying said seller, at least one transformation function for said seller, said at least one transformation function for use in transforming offers made by said seller in at least one buy-side auction.

31. The method of claim 30, further comprising:
communicating said at least one transformation function for said seller to an administrator of said at least one buy-side auction.

32. A method for conducting a buy-side auction having a plurality of seller competitively submitting offers to sell for an item requested by a buyer, the method comprising:
receiving, from a first seller, a first offer to sell said item;
identifying a transformation function associated with said first offer;
applying said transformation function to said first offer to produce a first transformed offer;
receiving, from a second seller, a second offer to sell said item;
identifying a second transformation function associated with said second offer;
applying said second transformation function to said second offer to produce a second transformed offer; and
comparing said first and second transformed offers and accepting the best one of said offers as the current best offer of said exchange.

33. A method for conducting an auction having a plurality of sellers competitively submitting offers to sell an item requested by a buyer, the method comprising:
receiving, from a first seller, a first transformed offer to sell said item, said first transformed offer produced by a first transformation function;
receiving, from a second seller, a second transformed offer to sell said item, said second transformed offer produced by a second transformation function; and
comparing said first and said second transformed offers and accepting the best as the current best offer of said auction.

34. A method for submitting an offer to sell an item in a buy-side auction, comprising:
generating an offer to sell said item;
identifying at least a first transformation function for said offer;
applying said at least first transformation function to said offer to generate a transformed offer; and
forwarding said transformed offer to an auction administrator.

35. A personalized dynamic pricing method, comprising:
identifying a first offer to sell an item in an auction;
applying a first transformation function to said first offer to generate a transformed first offer; and
updating a status of said auction to reflect said transformed first offer.

36. The method of claim 35, further comprising:
generating a transformed status of said auction.

37. A device for facilitating the acquisition of an item by a buyer in an auction involving a plurality of sellers, comprising:
means for defining a plurality of transformation functions available for use in said auction;
means for identifying an offer to sell said item, said offer made by one of said plurality of sellers;
means for selecting, based at least in part on said offer or said seller, at least one of said plurality of transformation functions;
means for applying said selected transformation function to said offer to produce a transformed offer; and
means for updating a state of said auction based on said transformed offer.

38. A computer-readable medium having computer-executable instructions for performing steps, comprising:
defining a plurality of transformation functions available for use in said auction;
identifying an offer to sell said item, said offer made by one of said plurality of sellers;
selecting, based at least in part on said offer or said seller, at least one of said plurality of transformation functions;
applying said selected transformation function to said offer to produce a transformed offer; and
updating a state of said auction based on said transformed offer.

39. A system for conducting a buy-side auction, comprising:
a processor;
a communications device, in communication with said processor, receiving a request for a status of said buy-side auction from a seller device; and
a memory unit in communication with said processor and storing a program, wherein said processor is operative with said program to
define a plurality of transformation functions available for use in said auction;
select, based at least in part on said request for status, at least a first one of said plurality of transformation functions;
apply said at least first transformation function to said status to generate a transformed status; and
forward said transformed status to said seller
